(19) United States
(12) Patent Application Publication
(10) Pub. No.: US 2012/0218395 A1
(43) Pub. Date: Aug. 30, 2012

(54) USER INTERFACE PRESENTATION AND INTERACTIONS

(75) Inventors: Jordan Andersen, Kirkland, WA (US); Ron Forbes, Seattle, WA (US)

(73) Assignee: MICROSOFT CORPORATION, Redmond, WA (US)

(21) Appl. No.: 13/035,299

(22) Filed: Feb. 25, 2011

(51) Int. Cl. H04N 7/18; G09G 5/00

(52) U.S. Cl. 348/77; 345/156; 348/E07.085

(57) ABSTRACT

Embodiments are disclosed that relate to push and/or pull user interface elements in a user interface with which a user interacts via a depth camera. One embodiment provides a computing device configured to display an image of a user interface comprising one or more interactive user interface elements, receive from a depth camera one or more depth images of a scene including a human target, and display a rendering of a portion of the human target as a cursor positioned within the user interface and also provide to the display a rendering of a shadow of the cursor cast on one or more of the interactive user interface elements. The computing device is further configured to translate movement of the human target hand to the cursor such that movement of the human target hand causes corresponding actuation of a selected interactive user interface element via the cursor.

### BACKGROUND

Computer technology enables humans to interact with computers in various ways. One such interaction may occur when humans use various input devices such as mice, track pads, and game controllers to actuate buttons on a user interface of a computing device.

### SUMMARY

Various embodiments are disclosed herein that relate to push and/or pull user interface elements in a user interface with which a user interacts via a depth camera. For example, one disclosed embodiment provides a computing device configured to provide to a display an image of a user interface comprising one or more interactive user interface elements, receive from a depth camera one or more depth images of a scene including a human target, and provide to the display a rendering of a portion of the human target as a cursor positioned within the user interface and also provide to the display a rendering of a shadow of the cursor cast on one or more of the interactive user interface elements. The computing device is further configured to translate movement of the hand of the human target to the cursor such that movement of the hand of the human target causes corresponding actuation of a selected interactive user interface element via the cursor. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a use environment for a user interface according to an embodiment of the present disclosure.

FIG. 2 schematically illustrates a human target in an observed scene being modeled with skeletal data according to an embodiment of the present disclosure.

FIG. 3 shows an embodiment of an interactive user interface element, and also shows an embodiment of a cursor hand spaced from the interactive user interface element.

FIG. 4 shows the cursor hand of FIG. 3 in contact with the interactive user interface element.

FIG. 5 shows the cursor hand of FIG. 3 interacting with the interactive user interface element of the embodiment of FIG. 3.

FIG. 6 shows a schematic depiction of an embodiment of a virtual lighting arrangement in a user interface space for casting shadows on a user interface via a user interface cursor.

FIG. 7 shows a schematic depiction of another embodiment of a virtual lighting arrangement in a user interface space for casting shadows on a user interface via a user interface cursor.

FIG. 8 shows a flow diagram depicting an embodiment of a method of operating a user interface.

FIG. 9 shows a block diagram of an embodiment of a computing system.

### DETAILED DESCRIPTION

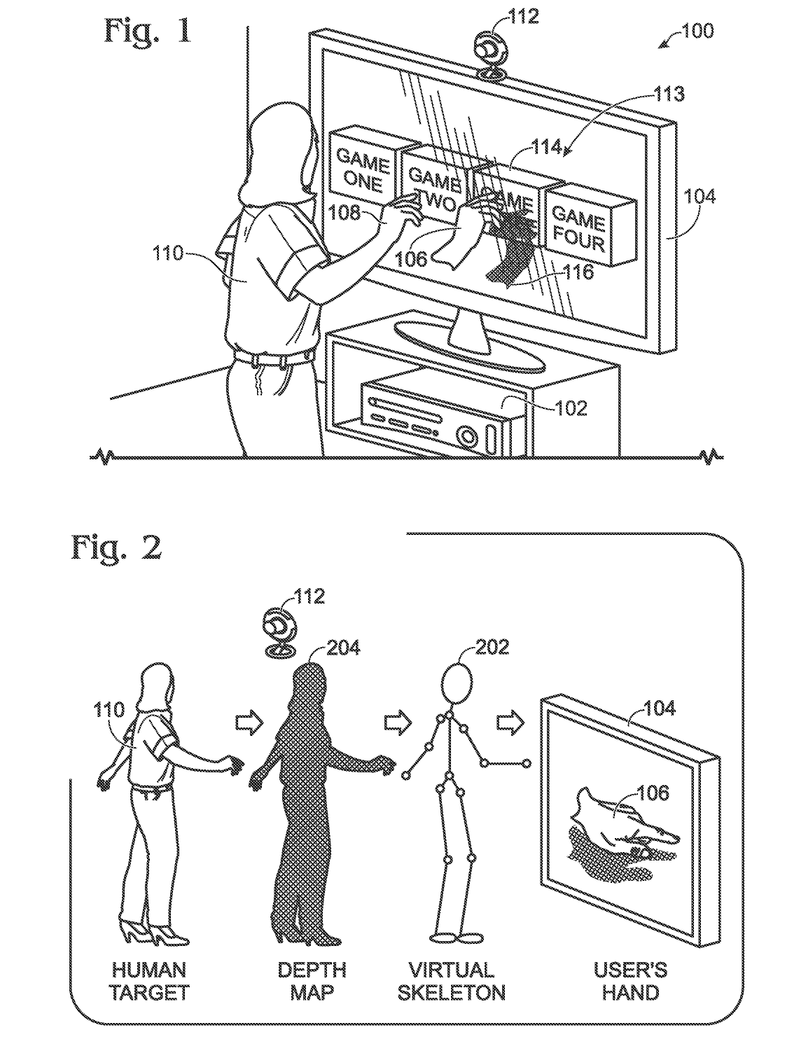

FIG. 1 shows a computing device 102 that may be used to play a variety of different games, play one or more different media types, and/or control or manipulate non-game applications and/or operating systems. FIG. 1 also shows a display device 104 such as a television or a computer monitor, which may be used to present game visuals and/or other output images to users.

As one example use of computing device 102, the display device 104 may be used to visually present a user interface cursor 106, shown in FIG. 1 in the form of a rendering of an image of a hand 108 of a human target 110 as acquired by a depth camera 112. In this instance, the human target 110 controls the cursor hand 106 via movements of hand 108. In this manner, the human target 110 can interact with a user interface 113, for example, by pushing and/or pulling interactive elements such as buttons, one of which is illustrated as button 114. In some embodiments, where a human tracking system can track finger movements, the human target 110 may be able to control movement of individual fingers of cursor hand 106.

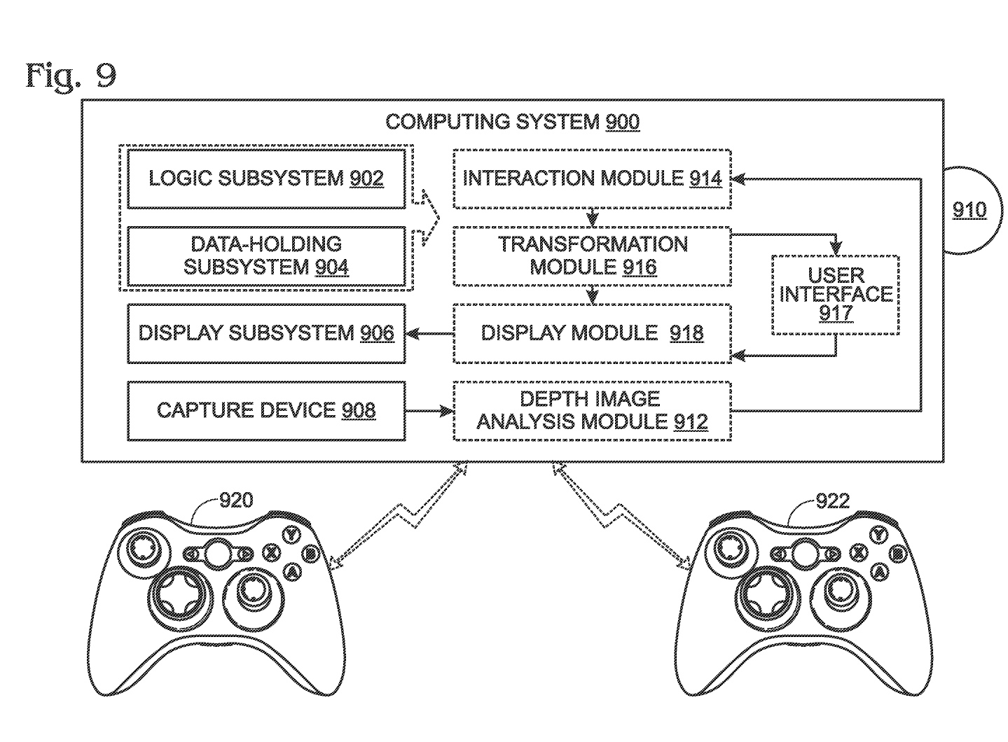

To help the human target 110 translate motions of hand 108 to the cursor hand 106 more intuitively, the computing device 102 may be configured to render one or more shadows 116 of the cursor hand 106 on the user interface 113 to provide depth and positional information regarding the position of the cursor hand 106 relative to the buttons. The depth camera 112 is discussed in greater detail with respect to FIG. 9. While disclosed herein in the context of a cursor in the form of a hand rendered from a depth image of a target player, it will be understood that the cursor may take any other suitable form, and may track or model any other suitable body part, such as a leg (e.g. for a game played in a reclined body position) or other portion of the human target.

Further, in some embodiments, a rendering of and a shadow of a larger part of a human target's body may be shown as a cursor and cursor shadow in a user interface according to the present disclosure. This may help, for example, to provide feedback to the human target that they need to step forward to interact with user interface elements. Casting a shadow of the entire body may help the user adjust the position of their body just as shadows from hand may help them position their hands. Further, such a shadow may be cast for aesthetic reasons. Additionally, objects that the human target is holding also may be rendered as part of the cursor in some embodiments. Further, in some embodiments, the cursor may have a more conceptual form, such as an arrow or other simple shape.

The human target 110 is shown here as a game player within an observed scene. The human target 110 is tracked via the depth camera 112 so that the movements of the human target 110 may be interpreted by the computing device 102 as controls that can be used to move the cursor hand 106 to select and actuate a user interface element, as well as to affect a game or other program being executed by the computing device 102. In other words, the human target 110 may use his or her movements to control the game.

The depth camera 112 also may be used to interpret target movements as operating system and/or application controls that are outside the realm of gaming. Virtually any controllable aspect of an operating system and/or application may be controlled by movements of the human target 110. The illustrated scenario in FIG. 1 is provided as an example, but is not meant to be limiting in any way. To the contrary, the illustrated scenario is intended to demonstrate a general concept, which may be applied to a variety of different applications without departing from the scope of this disclosure.

The methods and processes described herein may be tied to a variety of different types of computing systems. FIG. 1 shows a non-limiting example in the form of computing 102, display device 104, and depth camera 112. These components are described in more detail below with respect to FIG. 9.

FIG. 2 shows a simplified processing pipeline in which the human target 110 of FIG. 1 is modeled as a virtual skeleton that can be used to render an image of the cursor hand 106 (or other representation of the human target 110, such as an avatar) for display on the display device 104 and/or to serve as a control input for controlling other aspects of a game, application, and/or operating system. It will be appreciated that a processing pipeline may include additional steps and/or alternative steps than those depicted in FIG. 2 without departing from the scope of this disclosure. It also will be noted that some embodiments may model only a portion of a skeleton from a depth image. Further, some embodiments may utilize tracking systems such as hand tracking or even just motion tracking for user interface interaction as described herein.

As shown in FIG. 2, the human target 110 is imaged by depth camera 112. The depth camera 112 may determine, for each pixel, the depth of a surface in the observed scene relative to the depth camera. Virtually any depth finding technology may be used without departing from the scope of this disclosure. Example depth finding technologies are discussed in more detail with reference to FIG. 9.

The depth information determined for each pixel may be used to generate a depth map 204. Such a depth map 204 may take the form of any suitable data structure, including but not limited to a matrix that includes a depth value for each pixel of the observed scene. In FIG. 2, depth map 204 is schematically illustrated as a pixelated grid of the silhouette of human target 110. This illustration is for simplicity of understanding, and not technical accuracy. It is to be understood that a depth map generally includes depth information for all pixels, and not just pixels that image the human target 20, and that the perspective of depth camera 112 would not result in the silhouette depicted in FIG. 2.

A virtual skeleton 202 may be derived from depth map 204 to provide a machine readable representation of human target 110. In other words, virtual skeleton 202 is derived from the depth map 204 to model human target 110. The virtual skeleton 202 may be derived from the depth map 204 in any suitable manner. For example, in some embodiments, one or more skeletal fitting algorithms may be applied to the depth map 204. It will be understood that the present disclosure is compatible with any suitable skeletal modeling techniques.

The virtual skeleton 202 may include a plurality of joints, each joint corresponding to a portion of the human target 110. In FIG. 2, the virtual skeleton 202 is illustrated as a stick figure with plural joints. It will be understood that this illustration is for simplicity of understanding, not technical accuracy. Virtual skeletons in accordance with the present disclosure may include virtually any number of joints, each of which can be associated with virtually any number of parameters (e.g., three dimensional joint position, joint rotation, body posture of corresponding body part (e.g., hand open, hand closed, etc.) etc.). It is to be understood that a virtual skeleton may take the form of a data structure including one or more parameters for each of a plurality of skeletal joints (e.g., a joint matrix including an x position, a y position, a z position, and a rotation for each joint). In some embodiments, other types of virtual skeletons may be used (e.g., a wireframe, a set of shape primitives, etc.).

The virtual skeleton 202 may be used to render an image of the cursor hand 106 on the display device 104 as a visual representation of the hand 108 of the human target 110. Because the virtual skeleton 202 models the human target 110, and the rendering of the cursor hand 106 is based on the virtual skeleton 202, the cursor hand 106 serves as a viewable digital representation of the actual hand of the human target 110. As such, movement of the cursor hand 106 on the display device 104 reflects the movements of the human target 110. Further, the cursor hand 106 may be displayed from a first-person point of view or a near first-person view (e.g. from a perspective somewhat behind an actual first person perspective), such that the cursor hand 106 has a similar or same orientation as the hand of the human target 110. This may help the human target 110 to manipulate the cursor hand 106 more intuitively and easily. While disclosed herein in the context of skeletal mapping, it will be understood that any other suitable method of motion and depth tracking of a human target may be used. Further, it will be understood that the term “first-person perspective,” “first-person view” and the like as used herein signifies any perspective in which an orientation of a body part rendered as a cursor approximates or matches an orientation of the user's body part from the user's perspective.

As mentioned above with respect to FIG. 1, shadows of the cursor hand 106 may be rendered on the user interface 113 to provide depth and positional information regarding the position of the cursor hand 106 relative to the button 114 or other interactive user interface elements. The use of shadows in combination with the rendering of an image of the human target's 110 actual hands 108 may facilitate interactions of the human target with the user interface compared to other tracking-based 3D user interfaces. For example one difficulty in interacting with a user interface via a depth camera or other such human tracking-based 3D user interfaces involves providing sufficient spatial feedback to the user about the mapping between the input device and virtual interface. For such interactions to occur intuitively, it is helpful for a user to possess an accurate mental model of how movements in the real world map to the movements of an on-screen interaction device. In addition, it is helpful to display feedback to the user regarding where the cursor hand is in relation to interactive elements, which may be difficult information to portray on a 2D screen. Finally, it is helpful for the user interface to provide visual cues regarding the nature of the user action employed to engage with on-screen objects.

The use of a cursor rendered from skeletal data or other representation of a human target in combination with the rendering of shadows cast onto the user interface controls by the cursor may help to address these issues. For example, by modeling the movements, shape, pose, and/or other aspects of a cursor hand after the human target's own hand movements, shape, pose, etc., a user may intuitively control the cursor hand. Likewise, by casting one or more shadows of the cursor hand onto the user interface controls, the user is provided with feedback regarding the location of the cursor hand relative to the user interface controls. For example, as a user moves the cursor hand closer to and farther from an interactive element of a user interface, the shadow or shadows may respectively converge and diverge from the hand, thereby providing positional and depth feedback, and also hinting that a user may interact with the controls by contacting the controls with the cursor hand, for example, to push, pull, or otherwise actuate the controls.

In contrast, other methods of utilizing depth camera input to operate a user interface may not address such concerns. For example, one potential method of presenting a user interface may be to map a human target's three-dimensional motions to a two-dimensional screen space. However, sacrificing the third input dimension may decrease a range and efficiency of potential interactivity with the user interface, and also may place significant mental loads on the user to translate three-dimensional motions into expected two-dimensional responses, thereby potentially increasing a difficulty of targeting user interface controls. As such, a user may find it difficult to maintain engagement with a user interface element without the feedback provided by the use of the cursor hand in combination with the rendering of shadows. For example, a user attempting to push a user interface button may find that the cursor slides off of the user interface element due to ambiguity regarding how hand movements are mapped to user interface actions.

Likewise, where a three-dimensional input is mapped to a three-dimensional user interface, a user may experience depth perception problems where there is ambiguity regarding the hands position along the line from the eye to the button when the hand obscures the button. This may cause the user to fail to target a user interface element.

Part of the difficulty in making user inputs with three-dimensional motions may arise due to the existence of more than one mental model that may be applied when translating body motions to two-dimensional or three-dimensional user interface responses. For example, in one model, a position of a user interface cursor may be determined by projecting a ray from the depth camera onto the screen plane and scaling the coordinate planes to match each other. In this model, a user performs a three-dimensional user input (e.g. user inputs with a push and/or pull component) by moving a hand or other manipulator along the normal of the screen plane. In another model, rotational pitch and yaw of the hand relative to the shoulder are mapped to the screen plane. In such a radial model, a user performs three-dimensional user inputs by pushing directly away from the shoulder toward a user interface element, rather than normal to the screen. In either of these models, it may be difficult for a user to perform three-dimensional user inputs without feedback other than cursor motion. Thus, the rendering of an image of the user's hand as a cursor combined with the casting of shadows with the cursor hand may provide valuable feedback that allows a user to implicitly infer which of these models is correct, and thereby facilitate making such inputs.

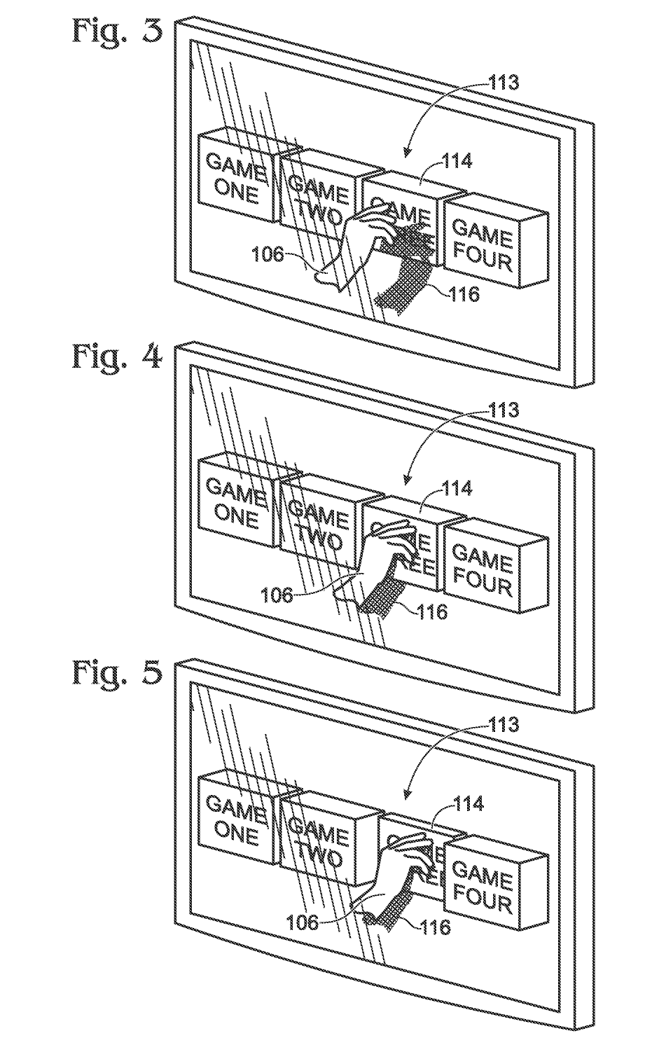

FIGS. 3-5 illustrate an appearance of the user interface 113 as the cursor hand 106 is moved toward and contacts the button 114. While a single cursor hand is shown interacting with the button 114, it will be understood that two or more hands may interact simultaneously with the button 114 in some embodiments, depending upon how many users are present and the nature of the user interface presented. First, FIG. 3 shows the cursor hand 106 spaced from the button. In this configuration, shadow 116 is laterally displaced from the cursor hand 106 on a surface of the button 114, thereby providing visual feedback regarding which button 114 the cursor hand 106 is hovering over, as well as regarding the spacing between the cursor hand 106 and the button 114. This may help a user to avoid actuating an undesired button.

Next, FIG. 4 shows the cursor hand 106 touching the button, but the button 114 is not yet depressed. As can be seen, the shadow 116 and the cursor hand 106 have converged on the surface of the button 114, thereby providing feedback regarding changes in spacing between these elements. In the depicted embodiment, a single shadow is shown, but it will be understood that two or more shadows may be cast by the cursor hand 106, as described in more detail below.

Next, FIG. 5 shows the cursor hand 106 depressing the button 114. As the cursor hand 106 engages the button 114, the button 114 may be shown as being gradually pushed into the screen, thereby offering continuous visual feedback that the button is being engaged. Further, the partially pushed-in button also provides visual feedback to the user about a direction in which the object is to be pushed to continue/complete the actuation. This may help to reduce a chance of a user “slipping” off of the button 114 during engagement. Further, a user may gain confidence by performing such inputs successfully, which may help the user to complete an input, and to perform future inputs, more quickly.

Collision detection between the cursor hand 106 and the button 114 may be performed via the point clouds (e.g. x,y,z pixel locations of points that define a shape of the user's hand) of a hand model determined from skeletal tracking data, or in any other suitable manner. While FIGS. 3-5 depict a pushable user interface button, it will be understood that any suitable interactive user interface element with any suitable component of movement normal to the plane of the screen of the display device 104 may be used, including but not limited to pushable and/or pullable elements. Further, while the cursor hand is depicted in FIGS. 3-5 as a solid rendering of the user's hand, it will be understood that any other suitable rendering may be used. For example, a cursor hand may be depicted as a stripe rendering by connecting horizontal rows or vertical columns of points in the point cloud of the user's hand, by connecting rows and columns of the point cloud to form a grid rendering, by point sprites shown at each point of the point cloud, by voxel rendering, or in any other suitable manner.

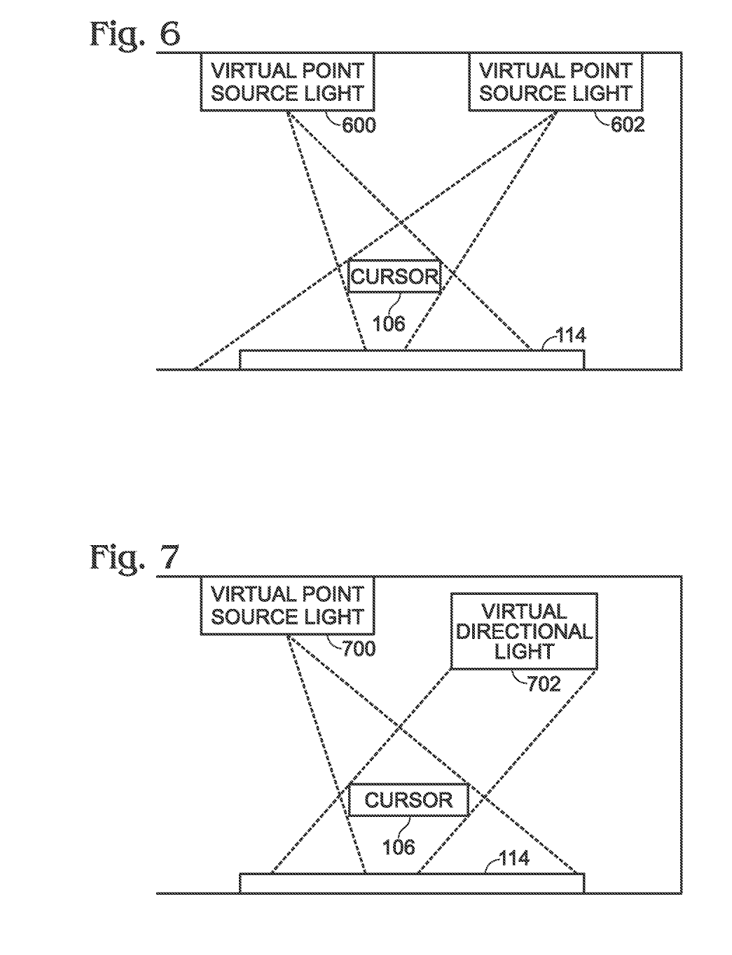

As mentioned above, any suitable number of shadows of a cursor hand may be used to show location and depth data. For example, in some embodiments a single shadow may be used, while in other embodiments, two or more shadows may be used. Further, the shadows may be generated by any suitable type or types of virtual light sources positioned at any suitable angle and/or distance relative to the cursor hand and/or the interactive user interface elements. For example, FIG. 6 shows a schematic depiction of the generation of two shadows as arising from virtual point light sources 600 and 602. Such sources may be configured to simulate interior lighting. The cursor hand 106 is illustrated schematically by a box labeled “hand”, which represents, for example, the point cloud representing the human target hand. As illustrated, the virtual point light sources 602 and 604 may be at different distances from and/or angles to the cursor hand 106 depending upon the location of the cursor hand 106. This may help to provide additional location information as the cursor hand 106 moves within the user interface.

The virtual light sources used to generate the shadow or shadows from the cursor hand 106 may be configured to simulate familiar lighting conditions to facilitate intuitive understanding of the shadows by a user. For example, the embodiment of FIG. 6 may simulate interior overhead lighting, such as living room lighting. FIG. 7 shows another virtual lighting scheme in which one virtual point light source 700 and one virtual directional light source 702 simulate an overhead light and sunlight from a window. It will be understood that the embodiments of FIGS. 6 and 7 are presented for the purpose of example, and are not intended to be limiting in any manner.

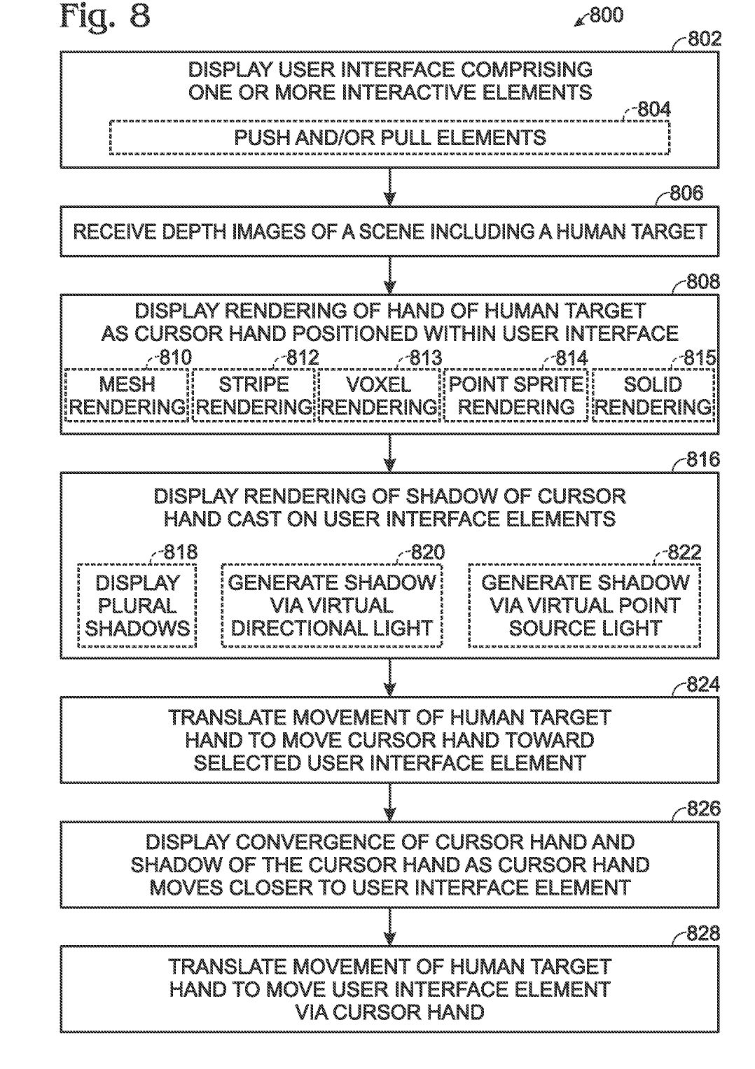

FIG. 8 shows a flow diagram depicting an embodiment of a method 800 of operating a user interface. It will be understood that method 800 may be implemented as computer-readable executable instructions stored on a removable or non-removable computer-readable storage medium. Method 800 comprises, at 802, providing to and displaying on a display device an image of a user interface comprising one or more interactive elements. As indicated at 804, the interactive user interface elements may include push and/or pull elements having a component of motion that is normal to a plane of a display screen, or may provide any other suitable feedback. Next, at 806, method 800 comprises receiving a three-dimensional input such as depth images of a scene including a human target. Then, method 800 comprises, at 808, providing to and displaying on the display device a rendering of a hand of the human target as a cursor hand positioned within the user interface. Any suitable rendering may be used, including but not limited to a mesh rendering 810, a stripe rendering 812, a voxel rendering 813, a point sprite rendering 814, a solid rendering 815, etc.

Method 800 next comprises, at 816, providing to and displaying on the display device a rendering of a shadow of the cursor hand cast on the user interface elements. As indicated at 818, in some embodiment, plural shadows may be displayed, while in other embodiments a single shadow may be displayed. The shadows may be generated via a virtual directional light, as indicated at 820, by a virtual point source light, as indicated at 822, or in any other suitable manner.

Next, method 800 comprises, at 824, translating movement of a human target hand to movement of the cursor hand toward a selected user interface element. As movement of the human target hand continues, method 800 comprises, at 826, displaying convergence of the cursor hand and the shadow or shadows of the cursor hand as the cursor hand moves closer to the selected user interface element due to the geometric relationship between the hand cursor, the shadow and the user interface element, and at 828, moving the user interface element via the cursor hand or causing other suitable corresponding actuation of the user interface element.

In some embodiments, the above described methods and processes may be tied to a computing system including one or more computers. In particular, the methods and processes described herein may be implemented as a computer application, computer service, computer API, computer library, and/or other computer program product.

FIG. 9 schematically shows a non-limiting computing system 900 that may perform one or more of the above described methods and processes. Computing system 900 is shown in simplified form. It is to be understood that virtually any computer architecture may be used without departing from the scope of this disclosure. In different embodiments, computing system 900 may take the form of a mainframe computer, server computer, desktop computer, laptop computer, tablet computer, home entertainment computer, network computing device, mobile computing device, mobile communication device, gaming device, etc.

Computing system 900 may include a logic subsystem 902, a data-holding subsystem 904, a display subsystem 906, and/or a capture device 908. The computing system may optionally include components not shown in FIG. 9, and/or some components shown in FIG. 9 may be peripheral components that are not integrated into the computing system.

Logic subsystem 902 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 904 may include one or more physical, non-transitory, devices configured to hold data and/or instructions executable by the logic subsystem to implement the herein described methods and processes. When such methods and processes are implemented, the state of data-holding subsystem 904 may be transformed (e.g., to hold different data).

Data-holding subsystem 904 may include removable media and/or built-in devices. Data-holding subsystem 904 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 904 may include devices with one or more of the following characteristics: volatile, nonvolatile, dynamic, static, read/write, read-only, random access, sequential access, location addressable, file addressable, and content addressable. In some embodiments, logic subsystem 902 and data-holding subsystem 904 may be integrated into one or more common devices, such as an application specific integrated circuit or a system on a chip.

FIG. 9 also shows an aspect of the data-holding subsystem in the form of removable computer-readable storage media 910, which may be used to store and/or transfer data and/or instructions executable to implement the herein described methods and processes. Removable computer-readable storage media 910 may take the form of CDs, DVDs, HD-DVDs, Blu-Ray Discs, EEPROMs, and/or floppy disks, among others.

It is to be appreciated that data-holding subsystem 904 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The term “module” may be used to describe an aspect of computing system 900 that is implemented to perform one or more particular functions. In some cases, such a module may be instantiated via logic subsystem 902 executing instructions held by data-holding subsystem 904. It is to be understood that different modules and/or engines may be instantiated from the same application, code block, object, routine, and/or function. Likewise, the same module and/or engine may be instantiated by different applications, code blocks, objects, routines, and/or functions in some cases.

Computing system 900 includes a depth image analysis module 912 configured to track a world-space pose of a human in a fixed, world-space coordinate system, as described herein. The term “pose” refers to the human's position, orientation, body arrangement, etc. Computing system 900 includes an interaction module 914 configured to establish a virtual interaction zone with a moveable, interface-space coordinate system that tracks the human and moves relative to the fixed, world-space coordinate system, as described herein. Computing system 900 includes a transformation module 916 configured to transform a position defined in the fixed, world-space coordinate system to a position defined in the moveable, interface-space coordinate system as described herein. Computing system 900 also includes a display module 918 configured to output a display signal for displaying an interface element at a desktop-space coordinate corresponding to the position defined in the moveable, interface-space coordinate system.

Computing system 900 includes a user interface module 917 configured to translate cursor movements in a user interface to actions involving the interface elements. As a nonlimiting example, user interface module 917 may analyze cursor movements relative to push and/or pull elements of the user interface to determine when such buttons are to be moved.

Display subsystem 906 may be used to present a visual representation of data held by data-holding subsystem 904. As the herein described methods and processes change the data held by the data-holding subsystem, and thus transform the state of the data-holding subsystem, the state of display subsystem 906 may likewise be transformed to visually represent changes in the underlying data. As a nonlimiting example, the target recognition, tracking, and analysis described herein may be reflected via display subsystem 906 in the form of interface elements (e.g., cursors) that change position in a virtual desktop responsive to the movements of a user in physical space. Display subsystem 906 may include one or more display devices utilizing virtually any type of technology, including but not limited to two-dimensional displays such as televisions, monitors, mobile devices, heads-up displays, etc., as well as three-dimensional displays such as three-dimensional televisions (e.g. viewed with eyewear accessories), virtual reality glasses or other head-mounted display, etc. Such display devices may be combined with logic subsystem 902 and/or data-holding subsystem 904 in a shared enclosure, or such display devices may be peripheral display devices, as shown in FIG. 1.

Computing system 900 further includes a capture device 908 configured to obtain depth images of one or more targets. Capture device 908 may be configured to capture video with depth information via any suitable technique (e.g., time-of-flight, structured light, stereo image, etc.). As such, capture device 908 may include a depth camera (such as depth camera 112 of FIG. 1), a video camera, stereo cameras, and/or other suitable capture devices.

For example, in time-of-flight analysis, the capture device 908 may emit infrared light to the target and may then use sensors to detect the backscattered light from the surface of the target. In some cases, pulsed infrared light may be used, wherein the time between an outgoing light pulse and a corresponding incoming light pulse may be measured and used to determine a physical distance from the capture device to a particular location on the target. In some cases, the phase of the outgoing light wave may be compared to the phase of the incoming light wave to determine a phase shift, and the phase shift may be used to determine a physical distance from the capture device to a particular location on the target.

In another example, time-of-flight analysis may be used to indirectly determine a physical distance from the capture device to a particular location on the target by analyzing the intensity of the reflected beam of light over time via a technique such as shuttered light pulse imaging.

In another example, structured light analysis may be utilized by capture device 908 to capture depth information. In such an analysis, patterned light (i.e., light displayed as a known pattern such as a grid pattern or a stripe pattern) may be projected onto the target. On the surface of the target, the pattern may become deformed, and this deformation of the pattern may be analyzed to determine a physical distance from the capture device to a particular location on the target.

In another example, the capture device may include two or more physically separated cameras that view a target from different angles, to obtain visual stereo data. In such cases, the visual stereo data may be resolved to generate a depth image.

In other embodiments, capture device 908 may utilize other technologies to measure and/or calculate depth values. Additionally, capture device 908 may organize the calculated depth information into “Z layers,” i.e., layers perpendicular to a Z axis extending from the depth camera along its line of sight to the viewer.

In some embodiments, two or more different cameras may be incorporated into an integrated capture device. For example, a depth camera and a video camera (e.g., RGB video camera) may be incorporated into a common capture device. In some embodiments, two or more separate capture devices may be cooperatively used. For example, a depth camera and a separate video camera may be used. When a video camera is used, it may be used to provide target tracking data, confirmation data for error correction of target tracking, image capture, face recognition, high-precision tracking of fingers (or other small features), light sensing, and/or other functions. In other embodiments, two separate depth sensors may be used.

It is to be understood that at least some target analysis and tracking operations may be executed by a logic machine of one or more capture devices. A capture device may include one or more onboard processing units configured to perform one or more target analysis and/or tracking functions. A capture device may include firmware to facilitate updating such onboard processing logic.

Computing system 900 may optionally include one or more input devices, such as controller 920 and controller 922. Input devices may be used to control operation of the computing system. In the context of a game, input devices, such as controller 920 and/or controller 922 can be used to control aspects of a game not controlled via the target recognition, tracking, and analysis methods and procedures described herein. In some embodiments, input devices such as controller 920 and/or controller 922 may include one or more of accelerometers, gyroscopes, infrared target/sensor systems, etc., which may be used to measure movement of the controllers in physical space. In some embodiments, the computing system may optionally include and/or utilize input gloves, keyboards, mice, track pads, trackballs, touch screens, buttons, switches, dials, and/or other input devices. As will be appreciated, target recognition, tracking, and analysis may be used to control or augment aspects of a game, or other application, conventionally controlled by an input device, such as a game controller. In some embodiments, the target tracking described herein can be used as a complete replacement to other forms of user input, while in other embodiments such target tracking can be used to complement one or more other forms of user input.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
a logic subsystem; and
a data holding subsystem comprising instructions stored thereon that are executable by the logic subsystem to:
provide to a display an image of a user interface comprising one or more interactive user interface elements;
receive from a depth camera one or more depth images of a scene including a human target;
provide to the display a rendering of a portion of the human target as a cursor positioned within the user interface and also provide to the display a rendering of a shadow of the cursor cast on one or more of the interactive user interface elements; and
translate movement of the hand of the human target to the cursor such that movement of the hand of the human target causes corresponding actuation of a selected interactive user interface element via the cursor.

2. The computing device of claim 1, wherein the instructions are further executable to display a convergence the cursor and the shadow of the cursor on the selected interactive user interface element as the cursor moves toward the selected interactive user interface element.

3. The computing device of claim 1, wherein the instructions are further executable to display a plurality of shadows of the cursor.

4. The computing device of claim 3, wherein the instructions are further executable to display the plurality of shadows as arising from light sources at different distances relative to the cursor and/or different angles relative to the cursor and a display screen normal.

5. The computing device of claim 1, wherein the instructions are further executable to render the shadow as arising from one or more of a virtual point light source and a virtual directional light source.

6. The computing device of claim 1, wherein the instructions are further executable to render the shadow as arising from a virtual directional light source.

7. The computing device of claim 1, wherein the instructions are further executable to show the cursor in the form of a hand rendered from a depth image of the hand of the human target.

8. The computing device of claim 1, wherein the instructions are further executable to provide the image of the user interface, cursor hand, and shadows to one or more of a two-dimensional display and a three-dimensional display.

9. The computing device of claim 1, wherein the instructions are further executable to translate movement of the hand of the human target to the cursor such that movement of the hand of the human target causes the cursor hand to contact the selected interactive user interface element, and to display corresponding push and/or pull movement of the selected interactive user interface element.

10. In a computing system comprising a computing device, a display, and a depth camera, a method of operating a user interface, the method comprising:
displaying on the display an image of a user interface comprising one or more push and/or pull user interface elements;
receiving from the depth camera one or more depth images of a scene including a human target;
displaying a rendering of a hand of the human target as a cursor hand positioned within the user interface and also displaying a rendering of a shadow of the cursor hand cast on one or more of the push and/or pull user interface elements;
translating movement of the hand of the human target to the cursor hand such that movement of the hand of the human target is displayed as motion of the cursor hand toward a selected push and/or pull user interface element and converge of the cursor hand and the shadow of the cursor hand on the selected push and/or pull user interface element; and
after the cursor hand contacts the selected push and/or pull user interface element, displaying push and/or pull movement of the selected push and/or pull user interface element.

11. The method of claim 10, further comprising displaying a rendering of a plurality of shadows of the cursor hand.

12. The method of claim 11, further comprising displaying a rendering of plural hands as plural cursor hands.

13. The method of claim 10, further comprising rendering the shadow of the cursor hand as arising from a virtual point light source.

14. The method of claim 10, further comprising rendering the shadow of the cursor hand as arising from a virtual directional light source.

15. The method of claim 10, further comprising displaying the cursor hand as one or more of a mesh rendering, a stripe rendering, a voxel rendering, and a point sprite rendering of a point cloud of the hand of the human target.

16. The method of claim 10, further comprising displaying the user interface, the rendering of the cursor hand and the rendering of the shadow on a two-dimensional display.

17. The method of claim 10, further comprising displaying the user interface, the rendering of the cursor hand and the rendering of the shadow on a three-dimensional display.

18. A computer-readable storage medium comprising instructions stored thereon that are executable by a computing device to perform a method of operating a user interface, the method comprising:
providing to a display an image of a user interface comprising one or more push and/or pull user interface elements;
receiving from a depth camera one or more depth images of a scene including a human target;
providing to the display a rendering of a hand of the human target as a cursor hand positioned within the user interface and also providing to the display a rendering of a plurality of shadows of the cursor hand cast on one or more of the push and/or pull user interface elements;
translating movement of the hand of the human target to the cursor hand such that movement of the hand of the human target is displayed as motion of the cursor hand toward a selected push and/or pull user interface element and converge of the cursor hand and the plurality of shadows of the cursor hand on the selected push and/or pull user interface element; and
after the cursor hand contacts the selected push and/or pull user interface element, displaying push and/or pull movement of the selected push and/or pull user interface element via the cursor hand.

19. The computer-readable storage medium of claim 18, wherein the computer-readable storage medium is a removable computer-readable storage medium.

20. The computer-readable storage medium of claim 18, wherein displaying the rendering of the plurality of shadows comprises displaying a rendering of a plurality of shadows arising from virtual light sources having different distances from the cursor hand and/or different angles relative to the cursor hand and a display screen normal.
